(19) United States
(12) Patent Application Publication
(10) Pub. No.: US 2026/0138661 A1
(43) Pub. Date: May 21, 2026

(54) Latch and Paddle for a Hand Truck

(71) Applicant: Magline, Inc., Standish, MI (US)

(72) Inventors: Scott Alexander Bokach, Wyoming, MI (US); Jesse Thomas Schopmeyer, Zeeland, MI (US); Chad David Winters, Bay City, MI (US); Gregory Paul Ecker, Midland, MI (US)

(21) Appl. No.: 19/360,372

(22) Filed: Oct. 16, 2025

Related U.S. Application Data
(60) Provisional application No. 63/723,207, filed on Nov. 21, 2024.

(51) Int. Cl. B62B 5/06; F16M 13/02

(52) U.S. Cl. CPC B62B 5/06; F16M 13/02

(57) ABSTRACT

The present invention relates to an improved latch and handle assembly for a hand truck. The assembly comprises a latch handle and a latching mechanism. The latching mechanism further includes a latch. The latch handle includes either a paddle handle, featuring an upper surface and a lower surface, or a pull handle, featuring a pull handle aperture. The paddle handle and/or pull handle are designed to offer a larger surface area for manipulation by a user's hand or foot. The latch handle is configured to shield latching mechanics in the latching mechanism from environmental elements, thereby extending its operational lifespan. The latch and handle assembly includes a first attachment point for connecting to a first cross bar of the hand truck and a second attachment point for connecting to a second cross bar.

### CROSS-REFERENCE TO RELATED APPLICATION

This application claims the benefit of the priority date of United States Provisional Application Serial No. 63/723,207, filed on November 21, 2024, the contents of that application being incorporated by reference herein in their entirety and for all purposes.

### FIELD OF INVENTION

The present invention generally relates to a hand truck, more specifically, an improved latch and handle assembly for easier handling. The present disclosure relates to light material handling equipment. Light material handling equipment encompasses a wide variety of wheeled carts, trollies, and hand trucks (e.g., dollies). These devices are typically manually operated by an operator who pushes or pulls the equipment. There are also motor-assisted (i.e., motorized) devices, which may include some type of device or mechanism to propel the device, truck, or cart without the operator having to exert a significant (or even zero) effort to cause the device to move.

### BACKGROUND

Hand trucks are widely used in various industries for transporting goods and materials. These trucks typically feature a handle and latch mechanism that allows users to maneuver and secure the truck during transport. However, traditional latch and handle designs present several problems that can hinder their effectiveness and usability.

One of the primary issues with conventional latch and handle assemblies is the limited surface area available for users to apply force. Handles with smaller surface areas can be difficult to operate, especially for users with limited hand strength or dexterity. This problem is exacerbated in conditions where users are wearing gloves or dealing with cold weather, making it challenging to achieve a secure grip and apply the necessary force to maneuver the truck.

Another significant problem is exposure of the internal latching mechanics to environmental elements such as dust, moisture, and debris. Traditional designs often lack protective features, leading to the ingress of contaminants that can cause wear and tear or mechanical failure. This exposure necessitates frequent maintenance and increases the likelihood of operational downtime, resulting in higher long-term costs and reduced reliability.

The attachment methods used in traditional latch and handle assembly designs are often complex and time-consuming, both during production and when performing maintenance. Complicated connection points, as well as multiple assemblies being required, can increase manufacturing costs and make it difficult for end-users to replace or repair the latch and handle assembly. This complexity can lead to prolonged downtime and reduced efficiency, particularly in industrial settings where quick repairs are essential.

Moreover, traditional latch and handle assemblies typically serve a singular function, either as i) a latch to secure the truck, or ii) as a handle to maneuver it. This limited functionality can be inefficient in dynamic environments where the truck needs to be frequently repositioned or transported over varying terrains. Users must often switch between different mechanisms to secure and move the truck, which can be cumbersome and time-consuming.

Ergonomic considerations are another area where traditional designs fall short. Handles that do not accommodate the natural shape of the hand or foot can cause strain and discomfort during use. This can lead to repetitive stress injuries and negatively impact the overall user experience. Additionally, handles that lack non-slip features can pose safety risks, as users may struggle to maintain a secure grip.

Traditional latch and handle assembly designs are often tailored to specific types of hand trucks, limiting their adaptability across different models and applications. This lack of universal compatibility can be a significant drawback for manufacturers and users who require standardized solutions for various truck handling and latching needs.

Aesthetic design is also an area where traditional latch and handle mechanisms may be lacking. In a competitive market, the visual appeal of a product can influence purchasing decisions. Handle and latch assemblies that do not align with the branding or visual identity of the hand truck manufacturer may be less attractive to potential buyers.

Finally, traditional latch and handle assembly designs often lack additional features that could enhance functionality and safety. For example, the absence of integrated locking mechanisms or sensors to provide feedback on the latch status can result in accidental disengagement during transport, posing safety risks and reducing overall reliability.

In summary, conventional latch and handle assemblies for hand trucks are deficient in several ways, including limited surface area for force application, exposure to environmental elements, complex attachment methods, singular functionality, poor ergonomics, lack of universal compatibility, insufficient aesthetic design, and absence of additional safety features. These problems collectively hinder the efficiency, reliability, and user-friendliness of hand trucks, necessitating the need for improved latch and handle assembly designs that address these shortcomings.

Generally, it is known to provide a wheeled device that typically stands vertically on two wheels and has an upper portion to be held by the operator to load carry cargo and to then tilt the loaded cargo and wheel the loaded cargo to a different location. It is also known to provide a hand truck including rear stabilizer wheels, which allow the hand truck to be tilted or leaned back and rested on the primary wheels as well as the rear stabilizer wheels. There is a wide variety of application-specific hand trucks based upon the above generally known designs. Such known application-specific hand trucks may be known as drum dollies (for moving 55-gallon drums), cylinder trucks (for moving high-pressure gas cylinders), tree dollies (for moving trees with ball roots), and water dollies (for moving multiple 5-gallon tanks of drinking water), to name only a few. It is generally known that any of these examples may be manually-operated or may be motor-assisted devices.

It is also generally known that there is a vast amount of known hand trucks for many different uses. The known hand trucks vary a great deal and may include simple mechanical clamping mechanisms to secure the load to the truck and/or to provide for manual braking devices. It is also further known to provide more complex and motorized hand trucks that can lift and lower loads. There are many adaptations and versions of hand trucks to meet the many varying needs of specific uses or applications, since a hand truck may be used in so many ways and in so many industries.

Accordingly, an improved system for unlatching and carrying the hand truck is needed in the industry.

### BRIEF DESCRIPTION OF THE DRAWINGS

The operation of the invention may be better understood by reference to the detailed description taken in connection with the following illustrations, wherein:

FIG. 1 illustrates several embodiments of a prior art hand truck in various models;

FIG. 2 illustrates several embodiments of a new novel hand truck in various models;

FIG. 3 illustrates a perspective view of the latch and handle according to one or more embodiments shown and described herein;

FIG. 4 illustrates a perspective view of the latch and handle according to one or more embodiments shown and described herein;

FIG. 5 illustrates a top view of the latch and handle according to one or more embodiments shown and described herein;

FIG. 6 illustrates a perspective view of the latch and handle according to one or more embodiments shown and described herein; and

FIG. 7 illustrates a top view of the latch and handle according to one or more embodiments shown and described herein.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

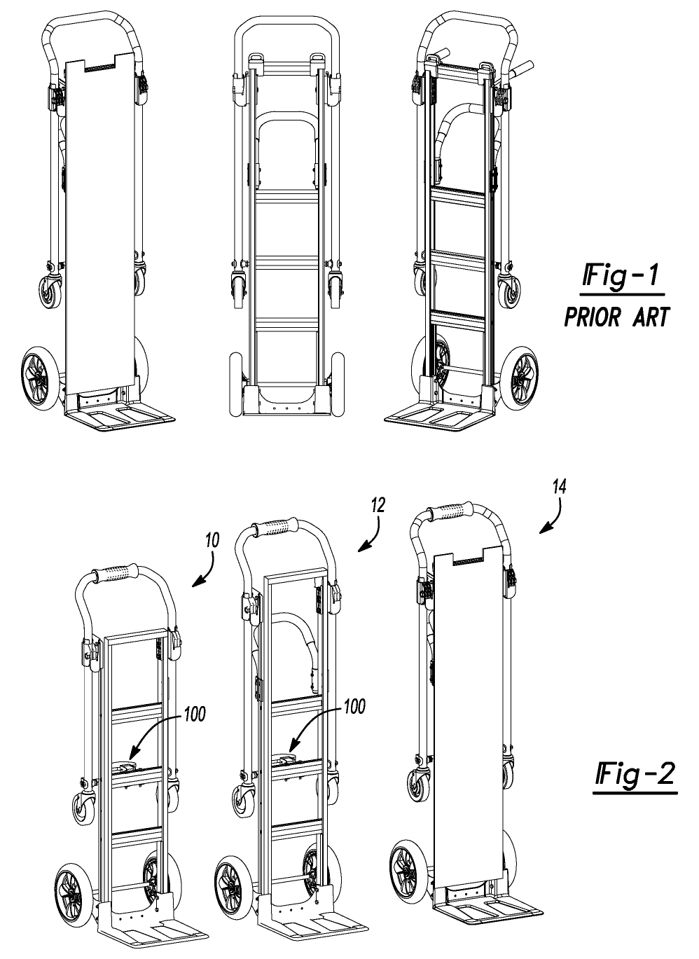

FIG. 1 illustrates hand trucks 10 known in the art. The hand trucks are depicted in various models 12, 14, 16. All models of the hand trucks 10 include a primary handle 18 used to push and maneuver the hand truck 10 during use.

FIG. 2 also depicts hand trucks in various models 12, 14, 16, all of which include a primary handle 18; however, the present figure also depicts the hand trucks 10 additionally including a latch and handle assembly 100. The latch and handle assembly 100 is separate from the primary handle 18 of the hand trucks 10. The latch and handle assembly 100 allows for release of the latching mechanism (not shown) in order to convert the hand truck 10 from a two-wheel mode to a four-wheel mode. Furthermore, when the hand truck 10 is in two-wheel mode, the latch and handle assembly 100 allows the user to grab the hand truck 10 therefrom and pull the hand truck from the load placed thereon. Lastly, the latch and handle assembly 100 allows the hand truck 10 to be lifted therefrom.

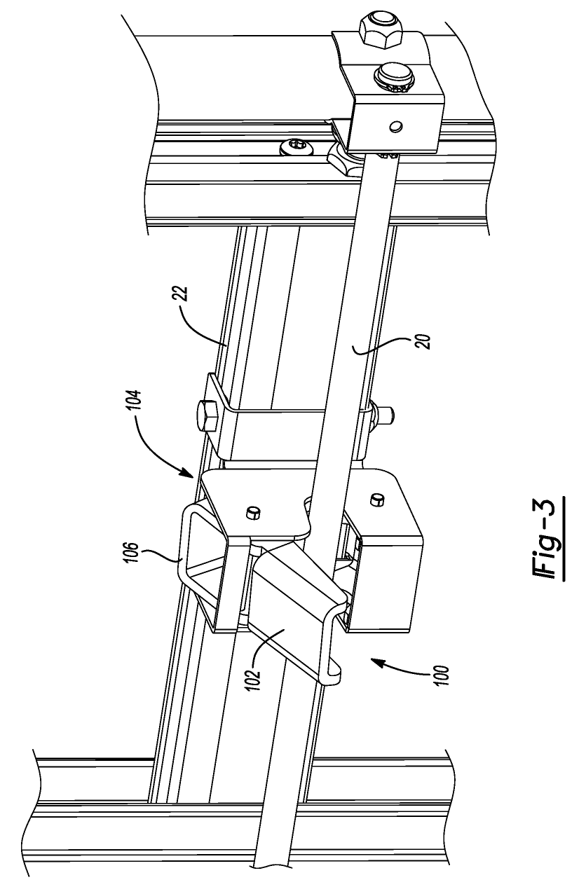

FIG. 3 illustrates a latch and handle assembly 100 as known in the prior art. The latch and handle assembly includes a latch handle 102 and a corresponding latching mechanism 104. The latching mechanism 104 further includes a latch 106. The latching mechanism 104 is affixed to a first cross bar 20 of the hand truck 10 at a first attachment portion 108. The latch handle 102, in conjunction with the latching mechanism 104, is able to engage a second cross bar 22 of the hand truck 10 at a second attachment portion 110 in order to secure the hand truck 10 for use.

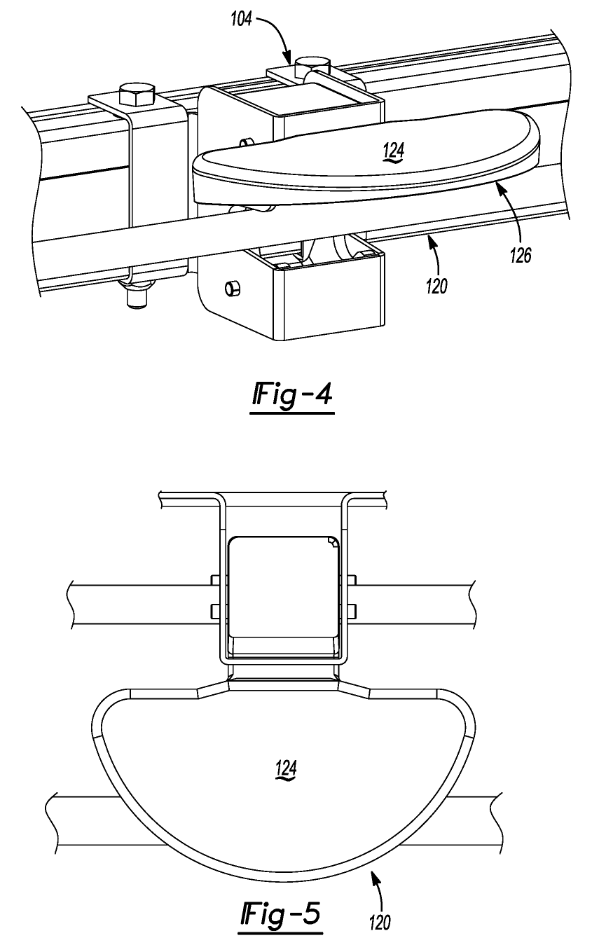

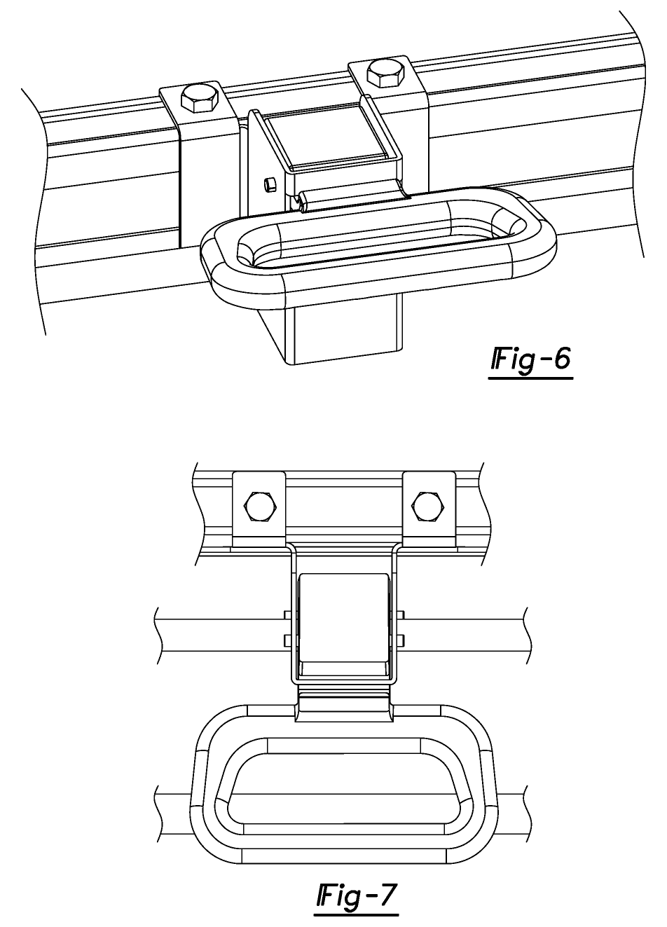

FIGS. 4-7 illustrate an improved latch and handle assembly 100 over the latch and handle assembly 100 known in the art, as depicted in FIG. 3. Specifically, FIGS. 4 and 5 illustrate an expanded-size paddle handle 120, and FIGS. 6 and 7 illustrate an expanded-size pull handle 130.

In FIGS. 4 and 5, the latch and handle assembly 100 includes the handle 102, wherein the handle 102 is in the shape of a paddle handle 120 with an expanded surface area. The latch and handle assembly 100 further includes a corresponding latching mechanism 104, including the latch 106. The latching mechanism 104 is affixed to a first cross bar 20 of the hand truck 10 at a first attachment point 108. The paddle handle 120 may be adapted to be manipulated such that the latching mechanism 104 is able to engage a second cross bar 22 of the hand truck 10 at a second attachment point 110.

In some embodiments, the paddle handle 120 includes an upper surface 124 and a lower surface 126. The paddle handle 120 configuration gives a larger surface area for manipulating the latch handle 102 with a hand or foot of the user. The larger paddle handle 120 generally provides for easier handling and increased manipulability. The upper surface 124 of the paddle handle 120 protects the latch mechanics.

In FIGS. 6 and 7, the latch and handle assembly 100 includes the handle 102, wherein the handle 102 is a pull handle 130. The pull handle 130 includes a pull handle aperture 132 which allows a user to insert and wrap their fingers around the pull handle 130. The latch and handle assembly 100 further includes a corresponding latching mechanism 104, including the latch 106. The latching mechanism 104 is affixed to a first cross bar 20 of the hand truck 10 at a first attachment point 108. The paddle handle 120 may be adapted to be manipulated such that the latching mechanism 104 is able to engage a second cross bar 22 of the hand truck 10 at a second attachment point 110.

In some embodiments, the latch and handle assembly 100 includes a push-pull handle. Specifically, a user can push down to release the latch and handle assembly 100 to transition the hand truck 10 into four-wheel mode. A user may pull on the latch and handle assembly 100 to extract the hand truck 10 from a load previously applied thereon. Additionally, a user may be able to lift the entire hand truck 10 by the latch and handle assembly 100. Such lifting may be required when transporting the hand truck 10 in and out of storage or from a transportation vehicle. When a user pulls or lifts the hand truck 10 by the latch and handle assembly 100, the latch and handle assembly 100 remains secure to the hand truck 10. The utility improvement is obtained by growing the function of the handle from a latch mechanism to a mechanism that acts as a latch as well as a handle to lift the truck, thus a push-pull handle.

The improved latch and handle mechanism offers several key advantages over traditional designs. Firstly, the increased surface area of the paddle handle 120 and/or the pull handle 130 allows users to apply force more effectively, whether by hand or foot. This is particularly beneficial in scenarios where the user may have limited hand strength or dexterity, such as when wearing gloves or dealing with cold weather conditions. The larger paddle handle 120 and/or pull handle 130 ensures that the force is distributed more evenly, reducing the likelihood of slippage and enhancing overall control.

Secondly, the protective upper surface 124 of the paddle handle 120 and/or a portion of the pull handle 130 shields the internal latching mechanics from environmental elements such as dust, moisture, and debris. This protective feature prolongs the lifespan of the latch mechanism by preventing the ingress of contaminants that could cause wear and tear or mechanical failure. As a result, the latch and handle assembly 100 requires less frequent maintenance, which translates to lower long-term costs and increased reliability.

The attachment method for the latch and handle assembly 100 depicted in the embodiments of FIGS. 4-7 has also been optimized for ease of production and service. The latching mechanism 104 may be affixed to the first cross bar 20 of the hand truck 10 at the first attachment point 108 via a bracket further secured by one or more bolts. Alternatively or additionally, the bracket may be tension fit, potentially negating the need for bolts. The bracket may be any shape suitable to engage with the first cross bar 20. By simplifying the attachment points 108 and 110 to the cross bars 20 and 22, the assembly process becomes more straightforward and less time-consuming.

Furthermore, in some embodiments, only a single latch and handle assembly 100 is needed. This provides lower production costs and construction complexity when compared with hand trucks known in the art that require two or more latch and handle assemblies. The singularly implemented latch and handle assembly 100 may be centrally located on the cross bar 20 of the hand truck 10 or can be located anywhere along the cross bar 20 of the hand truck 100. If desired, two or more latch and handle assemblies 100 may be utilized.

These improvement not only reduces manufacturing costs but also makes it easier for assembly as well as for end-users to replace or repair the latch and handle if necessary. The modular design allows for quick disassembly and reassembly, ensuring that downtime is minimized. Quick disassembly and reassembly are further realized with the implementation of a singular latch and handle assembly 100.In addition to its functional benefits, the push-pull handle design enhances the versatility of the hand truck 10. Users can now employ the latch handle 102 not only to secure the latching mechanim 104 but also to maneuver the hand truck 10 with greater ease. This dual functionality is particularly useful in dynamic environments where the hand truck 10 may need to be frequently repositioned or transported over varying terrains. The push-pull handle design effectively consolidates two separate actions into one seamless operation, improving overall efficiency.

The ergonomic considerations of the paddle handle 120 and/or pull handle 130 further contribute to user comfort and safety. The upper surface 124 and lower surface 126 of the paddle assembly and the pull handle aperture 132 of the pull handle 130 are contoured to fit the natural shape of the hand or foot, reducing strain during use. This ergonomic design minimizes the risk of repetitive stress injuries and enhances the overall user experience. Additionally, the handle’s material composition can be customized to provide a non-slip grip, further ensuring secure handling.

Moreover, the improved latch and handle assembly 100 can be integrated with various types of hand trucks 10 beyond the models depicted in the figures. This adaptability makes the design suitable for a wide range of applications, from industrial settings to consumer use. The universal compatibility of the latch and handle assembly 100 ensures that it can be adopted across different industries, providing a standardized solution for hand truck 10 handling and latching needs.

The aesthetic design of the latch and handle assembly 100 has also been considered. The sleek and modern appearance of the paddle handle 120 and/or pull handle 130 can be customized with different colors and finishes to match the branding or visual identity of the hand truck manufacturer. This attention to aesthetic detail enhances the overall appeal of the product, making it more attractive to potential buyers.

Furthermore, the improved latch and handle assembly 100 can be equipped with additional features such as locking mechanisms or sensors. For instance, a locking mechanism can be integrated into the latching mechanism 104 to secure the latch 106 in place, preventing accidental disengagement during transport. Sensors can be added to provide feedback on the latch status, alerting users if the latch 106 is not properly secured. These additional features enhance the functionality and safety of the latch and handle assembly 100.

In summary, the improved latch and handle assembly 100, as illustrated in FIGS. 4-7, represents a significant advancement in hand truck 10 design. The expanded size of the paddle handle 120 and/or pull handle, protective features, optimized attachment method, and push-pull functionality collectively contribute to a more efficient, reliable, and user-friendly product. These enhancements not only improve the handling and maneuverability of the hand truck 10 but also extend its lifespan and reduce maintenance costs. The versatility and adaptability of the design make it suitable for a wide range of applications, ensuring its relevance across different industries.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications, and substitutions without departing from the scope of the claims hereafter. The claims as follows are intended to include all modifications and alterations insofar as they come within the scope of the claims or the equivalent thereof.

It is noted that the terms "substantially" and "about" may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended, and all possible combinations of numerical values between the lowest value and the highest value enumerated are to be considered to be expressly stated in this application in a similar manner. As can be seen, the teaching of amounts expressed as "parts by weight" herein also contemplates the same ranges expressed in terms of percent by weight. Thus, an expression in the Detailed Description of the Invention of a range in terms of at "'x' parts by weight of the resulting polymeric blend composition" also contemplates a teaching of ranges of the same recited amount of "x" in percent by weight of the resulting polymeric blend composition."

Unless otherwise stated, all ranges include both endpoints and all numbers between the endpoints. The use of "about" or "approximately" in connection with a range applies to both ends of the range. Thus, "about 20 to 30" is intended to cover "about 20 to about 30", inclusive of at least the specified endpoints.

The term "consisting essentially of" to describe a combination shall include the elements, ingredients, components, or steps identified, and such other elements, ingredients, components, or steps that do not materially affect the basic and novel characteristics of the combination. The use of the terms "comprising" or "including" to describe combinations of elements, ingredients, components, or steps herein also contemplates embodiments that consist essentially of, or even consist of, the elements, ingredients, components, or steps.

Plural elements, ingredients, components, or steps can be provided by a single integrated element, ingredient, component or step. Alternatively, a single integrated element, ingredient, component, or step might be divided into separate plural elements, ingredients, components, or steps. The disclosure of "a" or "one" to describe an element, ingredient, component, or step is not intended to foreclose additional elements, ingredients, components, or steps. All references herein to elements or metals belonging to a certain group refer to the Periodic Table of the Elements published and copyrighted by CRC Press, Inc., 1989. Any reference to the group or groups shall be to the group or groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

What is claimed is:

1. An improved latch and handle assembly for a hand truck, comprising:
a latch handle;
a latching mechanism connected to the latch handle, the latching mechanism comprising a latch;
a first attachment point for connecting the latch and handle assembly to a frame of the hand truck; and
a second attachment point for connecting the latch and handle assembly to a cross bar of the hand truck;
wherein the latch handle includes a paddle handle, the paddle handle having an upper surface area and a lower surface area;
wherein the paddle handle is configured to provide a larger surface area for manipulation by a user’s hand or foot;
wherein the paddle handle is configured to protect latching mechanics in the latching mechanism from environmental elements, thereby prolonging the lifespan of the latching mechanics; and
wherein the latch and handle assembly is configured to function as both a latch and a handle for lifting the hand truck, thereby providing push-pull functionality.

2. The improved latch and handle assembly of claim 1, wherein the latch and handle assembly is configured to function as both the latch and the handle, such that:
the user can push down to release the latch and handle assembly to transition the hand truck into a four-wheel mode;
the user can pull on the latch and handle assembly to extract the hand truck from a load previously applied thereon; and/or
the user can lift the entire hand truck by the latch and handle assembly.

3. The improved latch and handle assembly of claim 1, wherein the paddle’s material composition is customized to provide a non-slip grip.

4. The improved latch and handle assembly of claim 1, further comprising a locking mechanism integrated with the latch to secure the latch in place and prevent accidental disengagement during transport.

5. An improved latch and handle assembly for a hand truck, comprising:
a latch handle;
a latching mechanism connected to the latch handle, the latching mechanism comprising a latch;
a first attachment point for connecting the latch and handle assembly to a frame of the hand truck; and
a second attachment point for connecting the latch and handle assembly to a cross bar of the hand truck;
wherein the latch handle includes a pull handle, the paddle handle having a pull handle aperture;
wherein the pull handle is configured to receive a user’s hand and to provide a larger surface area for manipulation by the user’s hand or foot;
wherein the pull handle is configured to protect latching mechanics from environmental elements, thereby prolonging the lifespan of the latching mechanics; and
wherein the latch and handle assembly is configured to function as both a latch and a handle for lifting the hand truck, thereby providing push-pull functionality.

6. The improved latch and handle assembly of claim 5, wherein the latch and handle assembly is configured to function as both the latch and the handle, such that:
the user can push down to release the latch and handle assembly to transition the hand truck into a four-wheel mode;
the user can pull on the latch and handle assembly to extract the hand truck from a load previously applied thereon; and/or
the user can lift the entire hand truck by the latch and handle assembly.

7. The improved latch and handle assembly of claim 5, wherein the paddle’s material composition is customized to provide a non-slip grip.

8. The improved latch and handle assembly of claim 5, further comprising a locking mechanism integrated with the latch to secure the latch in place and prevent accidental disengagement during transport.
